(19) United States
(12) Patent Application Publication
(10) Pub. No.: US 2026/0067618 A1
(43) Pub. Date: Mar. 5, 2026

(54) INFORMATION PROCESSING APPARATUS, AND INFORMATION PROCESSING METHOD

(71) Applicant: SHARP KABUSHIKI KAISHA, Sakai City (JP)

(72) Inventor: MITSUAKI KITAMURA, Sakai City (JP)

(21) Appl. No.: 19/312,647

(22) Filed: Aug. 28, 2025

(30) Foreign Application Priority Data
Sep. 3, 2024 (JP) 2024-151096

(51) Int. Cl. H04R 3/04

(52) U.S. Cl. CPC H04R 3/04; H04R 2430/01

(57) ABSTRACT

An information processing apparatus comprises a volume level information acquirer that acquires volume level information regarding a setting of a volume level by a user; and a signal processor that corrects a frequency characteristic of an output sound from a speaker and thus causes an attenuation amount from a maximum volume of the output sound from the speaker at a predetermined frequency to be within a range indicated by a volume lower limit value relative to the maximum volume at the predetermined frequency, according to the volume level indicated by the volume level information, wherein the volume lower limit value is determined according to a first sound pressure level difference at a reference frequency between the maximum volume of the speaker and a minimum audible volume that a human is capable of hearing and a second sound pressure level difference at different frequency different from the reference frequency between the maximum volume and the minimum audible volume, with a difference at the reference frequency between the maximum volume and a minimum volume that is settable for the output sound from the speaker as a reference.

### CROSS-REFERENCE TO RELATED APPLICATION

The present application claims priority from Japanese Application JP2024-151096, the content of which is hereby incorporated by reference into this application.

### BACKGROUND OF THE INVENTION

### 1. Field of the Invention

The present disclosure relates to an information processing apparatus and an information processing method.

### 2. Description of the Related Art

A human's sense of hearing has a characteristic that the perceived loudness of a sound varies depending on frequencies. Due to this characteristic, for example, when the loudness of a sound is small, the sound quality may deteriorate in a case of a sound in a low frequency range and a high frequency range being less audible than a sound in a middle frequency range, or the like. Known techniques for reducing such deterioration of the sound quality have been proposed. For example, JP 5041308 B discloses a technique of performing loudness correction by using a correction equalizer curve obtained by performing a broken line approximation on a correction curve obtained by differences between a plurality of curves corresponding to hearing levels of equal-loudness contours.

### SUMMARY OF THE INVENTION

However, the known techniques cannot sufficiently improve the sound quality in some cases. For example, a small speaker mounted on a mobile terminal such as a smartphone has a frequency characteristic in which the sound pressure in the middle range is higher than the sound pressure in the low range and the high range, compared to a larger speaker. Thus, even when the known technique is used to correct the frequency characteristic, there is a possibility that the sound pressure in the low frequency range and the high frequency range is not sufficiently secured. In particular, when the volume level of the output sound from the speaker is low, the sound pressure in the low frequency range and the high frequency range is not sufficiently high, and thus a user has difficulty in hearing the sound in the low frequency range and the high frequency range.

The present disclosure has been made in view of the problem described above. An object of the present disclosure is to provide an information processing apparatus and an information processing method that correct a frequency characteristic of an output sound from a speaker to make the sound easier to hear.

According to an embodiment of the present disclosure, there is provided an information processing apparatus including a volume level information acquirer that acquires volume level information regarding a setting of a volume level by a user, and a signal processor that corrects a frequency characteristic of an output sound from a speaker and thus causes an attenuation amount from a maximum volume of the output sound from the speaker at a predetermined frequency to be within a range indicated by a volume lower limit value relative to the maximum volume at the predetermined frequency, according to the volume level indicated by the volume level information, wherein the volume lower limit value is determined according to a first sound pressure level difference at a reference frequency between the maximum volume of the speaker and a minimum audible volume that a human is capable of hearing and a second sound pressure level difference at a different frequency different from the reference frequency between the maximum volume and the minimum audible volume, with a difference at the reference frequency between the maximum volume and a minimum volume that is settable for the output sound from the speaker as a reference.

According to an aspect of the present disclosure, there is provided an information processing method that is executed by an information processing apparatus, the information processing method including acquiring volume level information regarding a setting of a volume level by a user, and correcting a frequency characteristic of an output sound from a speaker and thus causing an attenuation amount from a maximum volume of the output sound from the speaker at a predetermined frequency to be within a range indicated by a volume lower limit value relative to the maximum volume at the predetermined frequency, according to the volume level indicated by the volume level information, wherein the volume lower limit value is determined according to a first sound pressure level difference at a reference frequency between the maximum volume of the speaker and a minimum audible volume that a human is capable of hearing and a second sound pressure level difference at a different frequency different from the reference frequency between the maximum volume and the minimum audible volume, with a difference at the reference frequency between the maximum volume and a minimum volume that is settable for the output sound from the speaker as a reference.

According to the present disclosure, an information processing apparatus and an information processing method that correct a frequency characteristic of an output sound from a speaker to make the sound easier to hear can be provided.

### BRIEF DESCRIPTION OF THE DRAWINGS

The disclosure will be described with reference to the accompanying drawings, wherein like numbers reference like elements.

FIG. 1 is a functional block diagram illustrating a schematic configuration of a sound output apparatus according to an embodiment.

FIG. 2 is a diagram schematically illustrating a relationship between an audible range for humans and a sound pressure level of an output sound from a speaker.

FIG. 3 is a diagram schematically illustrating an example of an attenuation amount of a signal level of a sound signal at each volume level.

FIG. 4 is a diagram schematically illustrating another example of an attenuation amount of a signal level of a sound signal at each volume level.

FIG. 5 is a diagram schematically illustrating another example of equalization processing.

FIG. 6 is a diagram schematically illustrating an example of an attenuation amount of a signal level in equalization processing.

FIG. 7 is a diagram schematically illustrating another example of the attenuation amount of the signal level in the equalization processing.

FIG. 8 is a diagram schematically illustrating another example of the attenuation amount of the signal level in the equalization processing.

FIG. 9 is a diagram schematically illustrating another example of the attenuation amount of the signal level in the equalization processing.

### DETAILED DESCRIPTION OF THE INVENTION

Embodiments of the present disclosure will be described below with reference to the drawings. Note that in the drawings, the same or equivalent constitutional elements are denoted by the same reference signs, and redundant descriptions of the same or equivalent constitutional elements will be omitted as appropriate.

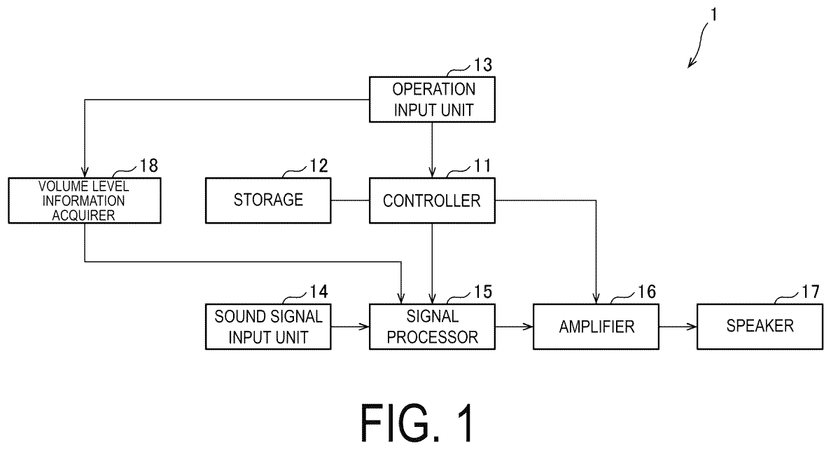

FIG. 1 is a functional block diagram illustrating a schematic configuration of a sound output apparatus 1 according to an embodiment. As illustrated in FIG. 1, the sound output apparatus 1 includes, as functional units, a controller 11, a storage 12, an operation input unit 13, a sound signal input unit 14, a signal processor 15, an amplifier 16, a speaker 17, and a volume level information acquirer 18. One or some of the functional units included in the sound output apparatus 1 function as an information processing apparatus in the present disclosure. In the example illustrated in FIG. 1, the information processing apparatus includes at least the signal processor 15. In the present embodiment, the sound output apparatus 1 is obtained by using a terminal device such as a smartphone. Note that the sound output apparatus 1 may be obtained by using another device.

The controller 11 controls and manages the entire sound output apparatus 1, including each functional unit of the sound output apparatus 1. The controller 11 performs various types of control by, for example, operating a program stored in the storage 12. For example, the controller 11 can be constituted by a control device such as a Central Processing Unit (CPU) or a Micro Processing Unit (MPU). The controller 11 outputs a sound from the speaker 17, based on, for example, an operation input by a user.

The storage 12 is a storage medium that can store a program and data. The storage 12 can be constituted by, for example, a semiconductor memory, a magnetic memory, or the like. Specifically, the storage 12 may be constituted by, for example, an Electrically Erasable Programmable Read-Only Memory (EEPROM), or a hard disk device. The storage 12 may store, for example, a program for operating the controller 11, and the like. Additionally, the storage 12 may store, for example, sound data (for example, a sound content) to be output from the speaker 17.

The operation input unit 13 receives an operation input from a user. The operation input unit 13 can be constituted by, for example, operation buttons (operation keys), a touch screen, or the like. The user can perform an operation input for starting or stopping the output of a sound on the operation input unit 13. Alternatively, the user can perform an operation input for changing the volume level of an output sound from the speaker. When the controller 11 receives the operation input by the user, the controller 11 starts or stops the output of the sound from the speaker 17, or changes the volume of the output sound from the speaker 17.

The sound signal input unit 14 receives an input of a sound signal. The sound signal is, for example, a sound signal of sound data stored in the storage 12. Alternatively, the sound signal may be a sound signal of a content acquired from an external device through communication connection. The sound signal input unit 14 provides the received sound signal to the signal processor 15.

The signal processor 15 performs signal processing on the sound signal acquired from the sound signal input unit 14. The signal processor 15 includes, for example, a Digital Signal Processor (DSP), and decodes the sound signal. The signal processor 15 performs the signal processing such as delay processing and equalization processing on the decoded sound signal. The signal processor 15 provides the processed sound signal to the amplifier 16.

In the present embodiment, the signal processor 15 corrects the frequency characteristic of the output sound from the speaker 17 as the equalization processing. The correction processing of the frequency characteristic that is executed by the signal processor 15 will be described in details below.

The amplifier 16 amplifies the sound signal acquired from the signal processor 15 and provides the amplified sound signal to the speaker 17.

The speaker 17 is driven based on the sound signal acquired from the amplifier 16 and outputs a sound. This reproduces the sound.

The volume level information acquirer 18 acquires volume level information related to a setting of the volume level by the user. Specifically, the volume level information acquirer 18 acquires the volume level information indicating the set volume level, based on the operation related to the setting of the volume level on the operation input unit 13 by the user. The volume level information acquirer 18 provides the acquired volume level information to the signal processor 15.

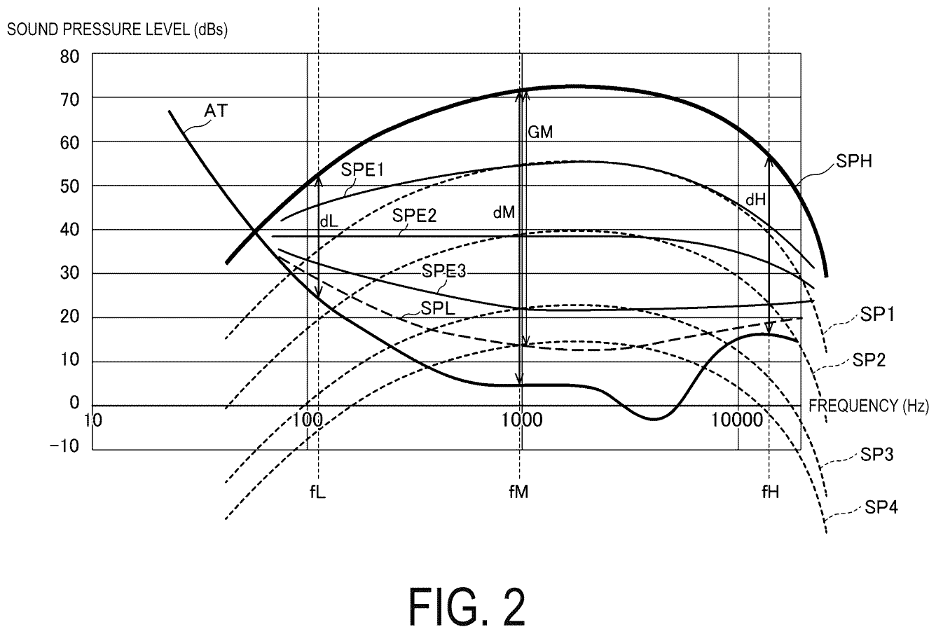

Next, the correction processing of the frequency characteristic that the signal processor 15 performs will be described in details. FIG. 2 is a diagram schematically illustrating a relationship between an audible range for humans and a sound pressure level of an output sound from the speaker. In FIG. 2, the horizontal axis represents frequency (Hz), and the vertical axis represents sound pressure level (dBs). Note that FIG. 2 is a semi-logarithmic graph in which the horizontal axis uses a logarithmic scale.

In FIG. 2, a frequency characteristic SPH indicates the maximum volume of the output sound from the speaker 17. In FIG. 2, a frequency characteristic AT indicates a minimum audible volume that humans can hear, and specifically indicates the minimum audible volume of equal-loudness level contours. Thus, when the sound is output from the speaker 17 at the maximum volume, humans can hear the sound within a frequency range in which the frequency characteristic SPH of the maximum volume is equal to or higher than the audible frequency characteristic AT.

Here, it is assumed that the user operates the operation input unit 13 to lower the volume level of the output sound from the speaker. In a case where the signal processor 15 does not correct the frequency characteristic, the frequency characteristic of the output sound from the speaker 17 decreases in sound pressure level with the same shape as that of the frequency characteristic SPH of the maximum volume, as the volume level is decreased. For example, in a case where the frequency characteristic is not corrected, the frequency characteristic of the output sound from the speaker 17 exhibits the frequency characteristic SP1 in FIG. 2 when the volume level is lowered by one level from the maximum volume SPH, exhibits the frequency characteristic SP2 in FIG. 2 when the volume level is lowered by two levels, exhibits the frequency characteristic SP3 in FIG. 2 when the volume level is lowered by three levels, and exhibits the frequency characteristic SP4 in FIG. 2 when the volume level is lowered by four levels. As described above, as the volume level is lowered, the frequency characteristic changes from SPH to SP1, SP2, SP3, and SP4, and accordingly, the frequency range in which the frequency characteristic of the output sound from the speaker 17 is equal to or higher than the audible frequency characteristic AT becomes narrower. This tendency is noticeable particularly in the low and high frequency bands. Thus, in a case where the frequency characteristic is not corrected, when the volume level is lowered, the frequency range of the sound that the user can hear is narrowed. This disables the user to hear the sound with sufficient sound quality.

Thus, the sound output apparatus 1 according to the present embodiment corrects the frequency characteristic of the output sound from the speaker 17 in the signal processor 15. Specifically, the signal processor 15 corrects the frequency characteristic of the output sound from the speaker 17, according to the volume level indicated by the volume level information, such that the attenuation amount from the maximum volume SPH of the output sound from the speaker 17 at a predetermined frequency is within the range indicated by the volume lower limit value relative to the maximum volume SPH at the predetermined frequency.

The volume lower limit value is a frequency characteristic at a volume level of the lowest stage at which the sound is output from the speaker 17 in a state after the correction of the frequency characteristic. Thus, the volume lower limit value is a frequency characteristic at the minimum volume except for the case where the output sound from the speaker 17 is 0. The volume lower limit value is set as an appropriate characteristic that is equal to or less than the frequency characteristic SPH and equal to or larger than the frequency characteristic AT in a frequency range in which the frequency characteristic SPH of the maximum volume is equal to or larger than the frequency characteristic AT. In FIG. 2, the volume lower limit value is indicated by the frequency characteristic SPL.

The frequency characteristic SPL of the volume lower limit value is determined by, for example, the sound output apparatus 1 or another external apparatus. Here, an example of a determination method for the volume lower limit value SPL will be described. The volume lower limit value SPL can be determined by setting a specific frequency as a reference frequency and using a sound pressure level difference between the maximum volume SPH of the speaker 17 and the minimum audible volume AT for humans at the reference frequency. The reference frequency can be determined as appropriate. The reference frequency may be, for example, a specific frequency in a mid-frequency band. The frequency in the mid-frequency band is, for example, a frequency within a range of 800 Hz to 6 kHz, more specifically, a frequency within a range of 1 kHz to 2 kHz. Here, as illustrated in FIG. 2, the frequency of 1 kHz belonging to the mid-frequency band is used as a reference frequency fM.

In FIG. 2, the sound pressure level difference between the maximum volume SPH of the speaker 17 and the minimum audible volume AT for humans at the reference frequency fM is indicated by dM. In the present specification, the sound pressure level difference between the maximum volume SPH of the speaker 17 and the minimum audible volume AT for humans at the reference frequency fM is hereinafter also referred to as a “first sound pressure level difference”.

When the sound pressure level difference between the maximum volume SPH and the minimum audible volume AT at a specific frequency different from the reference frequency fM is defined as a second sound pressure level difference, the volume lower limit value SPL is determined according to the first sound pressure level difference dM and the second sound pressure level difference with reference to the difference at the reference frequency fM between the maximum volume SPH of the speaker 17 and the minimum volume that can be set as the output sound from the speaker 17. The difference at the reference frequency fM between the maximum volume SPH of the speaker 17 and the minimum volume that can be set as the output sound from the speaker 17 is indicated as GM in FIG. 2.

Here, an example of a case where the specific frequency includes a low frequency fL lower than the reference frequency fM and a high frequency fH higher than the reference frequency fM will be described. The low frequency fL may be an appropriate frequency lower than the reference frequency fM, and may be, for example, a frequency within a range of 80 Hz to 200 Hz, more specifically, within a range of 100 Hz to 120 Hz. The high frequency fH may be an appropriate frequency higher than the reference frequency fM, and may be, for example, a frequency within a range of 8 kHz to 16 kHz, more specifically, a frequency within a range of 10 kHz to 12 kHz.

The second sound pressure level difference dL where the specific frequency is the low frequency fL is a sound pressure level difference between the maximum volume SPH and the minimum audible volume AT at the low frequency fL. Thus, the volume lower limit value SPL at the low frequency fL is determined according to the first sound pressure level difference dM and the second sound pressure level difference dL with reference to the difference GM at the reference frequency fM. As an example, the volume lower limit value SPL at the low frequency fL is determined by the following Equation (1).

$$SPL = SPH - ( dL / dM ) \cdot GM \qquad ( 1 )$$

Similarly, the second sound pressure level difference dH where the specific frequency is the high frequency fH is a sound pressure level difference between the maximum volume SPH and the minimum audible volume AT at the high frequency fH. Thus, the volume lower limit value SPL at the high frequency fH is determined according to the first sound pressure level difference dM and the second sound pressure level difference dH with reference to the difference GM at the reference frequency fM. As an example, the volume lower limit value SPL at the high frequency fH is determined by the following Equation (2).

$$SPL = SPH - ( dH / dM ) \cdot GM \qquad ( 2 )$$

The volume lower limit value SPL may be determined according to the first sound pressure level difference dM and the second sound pressure level difference for the entire predetermined frequency range. For example, the volume lower limit value SPL may be determined by calculations in accordance with Equations (1) and (2) described above on the entire frequency range from 80 Hz to 16 kHz. When determined in this manner, the volume lower limit value SPL exhibits a frequency characteristic as illustrated in FIG. 2, for example.

Alternatively, the volume lower limit value SPL may be determined according to the first sound pressure level difference dM and the second sound pressure level difference for the reference frequency fM and the specific frequency. In the example described above, the volume lower limit value SPL may be determined according to the first sound pressure level difference dM and the second sound pressure level differences dL and dH for the reference frequency fM, the low frequency fL, and the high frequency fH. In this case, for frequencies other than the reference frequency fM and the specific frequency (that is, in this example, frequencies other than the reference frequency fM, the low frequency fL, and the high frequency fH), the volume lower limit value SPL may be determined to be values obtained by connecting the volume lower limit values determined for the reference frequency fM and the specific frequency. When determined in this manner, the volume lower limit value SPL indicates a frequency characteristic connected by a straight line, a curved line, or the like as appropriate for the frequency band between the reference frequency fM and the specific frequency.

In the above example, the case where the specific frequency includes the low frequency fL and the high frequency fH has been described, but the specific frequency need not necessarily include both the low frequency fL and the high frequency fH. For example, the specific frequency may include at least one of the low frequency fL and the high frequency fH. Further, the specific frequency need not necessarily include one low frequency fL or one high frequency fH. The specific frequency may include a plurality of low frequencies fL or a plurality of high frequencies fH that are different from each other.

The signal processor 15 corrects the frequency characteristic of the output sound from the speaker 17 such that the attenuation amount from the maximum volume SPH of the output sound from the speaker 17 at the predetermined frequency is within the range indicated by the volume lower limit value determined as described above, according to the volume level indicated by the volume level information, by using the volume lower limit value determined as described above. Since the volume level information is information related to the setting of the volume level by the user, it also means that the signal processor 15 corrects the frequency characteristic of the output sound from the speaker 17 such that the attenuation amount described above is within the range indicated by the volume lower limit value according to the setting of the volume level by the user. It is to be noted that, in the present specification, the attenuation amount indicates an attenuation amount from the maximum volume SPH, and thus a numerical value indicating the attenuation amount is a positive value. That is, since the sound pressure level after attenuation is lower than the maximum volume SPH, the attenuation changes in the negative direction with reference to the maximum volume SPH. However, in the present specification, an amount of the change is described as the attenuation amount, and thus the amount itself has a positive numerical value.

The signal processor 15 may determine in advance the frequency characteristic of the output sound from the speaker 17 after correction for each selectable volume level with respect to the output volume from the speaker 17 with reference to the volume lower limit value SPL. For example, it is assumed that four volume levels can be set in addition to the maximum volume and the sound volume of 0. In this case, as illustrated in FIG. 2, the signal processor 15 can set the frequency characteristic after the correction when the volume level is lowered by one level from the maximum volume SPH as SPE1, set the frequency characteristic after the correction when the volume level is lowered by two levels as SPE2, set the frequency characteristic after the correction when the volume level is lowered by three levels as SPE3, and set the frequency characteristic after the correction when the volume level is lowered by four levels as the volume lower limit value SPL. These frequency characteristics SPE1, SPE2, and SPE3 may be set such that the attenuation amount from the maximum volume SPH at the reference frequency fM is equal to the attenuation amount before the correction of the frequency characteristic. Thus, for example, as illustrated in FIG. 2, the frequency characteristics SPE1, SPE2, and SPE3 coincide with the frequency characteristics SP1, SP2, and SP3, respectively, at the reference frequency fM (lines of the graph are in contact with each other).

In this manner, by setting the frequency characteristic after the correction between the maximum volume SPH and the volume lower limit value SPL, the sound pressure level of the output sound from the speaker 17 can be corrected according to the characteristic of the speaker 17. Thus, even when the volume level of the output sound is lowered, the frequency band of the sound that the user can hear is less likely to be narrowed. For example, even when the volume level of the output sound is lowered, the user can easily hear the sound in the low frequency band and the high frequency band.

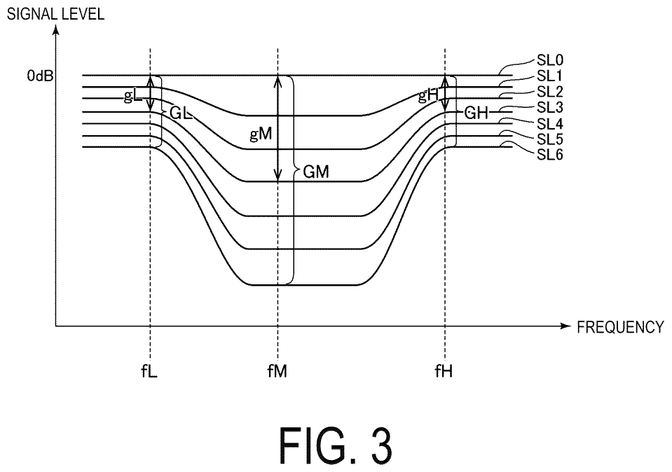

Here, a determination method for the attenuation amount from the maximum volume for each volume level of the speaker 17 by the signal processor 15 will be described in details. FIG. 3 is a diagram schematically illustrating an example of the attenuation amount of the signal level of the sound signal for each volume level, and is a diagram illustrating an equalizing characteristic for the set volume level. In FIG. 3, the horizontal axis represents frequency (Hz), and the vertical axis represents signal level (dB). FIG. 3 is a semi-logarithmic graph in which the horizontal axis uses a logarithmic scale. In FIG. 3, a state in which the signal level is not attenuated is defined as 0 dB, and the attenuation amount of the signal level is indicated by the magnitude of displacement in the negative direction.

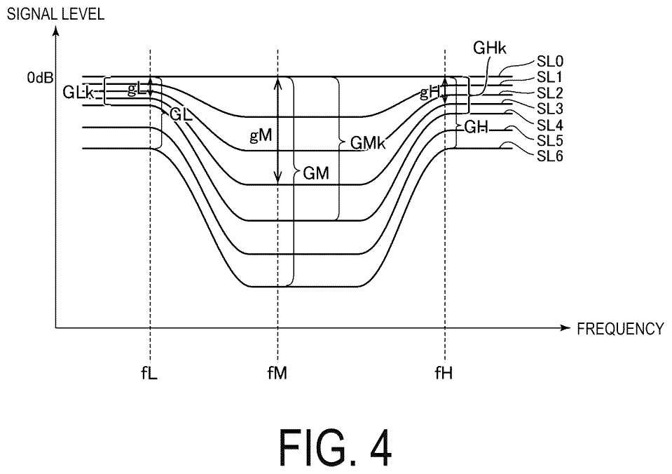

In FIG. 3, a graph line SL0 of a signal level of 0 dB is a graph where the signal level is not attenuated, and corresponds to a case of the maximum volume SPH in the frequency characteristic illustrated in FIG. 2. Additionally, in FIG. 3, a graph line SL6 of the lowest signal level is a graph line where the attenuation amount of the signal level is maximum, and indicates an attenuation state of the signal level executed in a case of the volume lower limit value SPL with the maximum attenuation amount of the signal level in the frequency characteristic illustrated in FIG. 2. Note that FIG. 2 illustrates an example where the volume level is lowered by four levels from the maximum volume SPH, and FIG. 3 illustrates an example where the volume level is lowered by six levels from the maximum volume. Thus, the graph of the signal level illustrated in FIG. 3 does not completely correspond to the graph of the frequency characteristic illustrated in FIG. 2. However, it is to be noted that the basic idea regarding the correction of the frequency characteristic is the same regardless of the number of levels. This point is the same or similar in FIG. 4 and the subsequent figures.

The signal processor 15 can determine the attenuation amount for each volume level by various methods. For example, the signal processor 15 can determine the attenuation amount based on a ratio between the first sound pressure level difference and the second sound pressure level difference. In the example illustrated in FIG. 3, an attenuation rate of the attenuation amount at the predetermined frequency based on the setting of the volume level by the user is the same as an attenuation rate of the attenuation amount at the reference frequency fM. That is, the attenuation rate is uniform at each frequency.

Specifically, as illustrated in FIG. 3, a difference in signal level at the reference frequency fM between the maximum volume SPH of the speaker 17 and the minimum volume that can be set for the output sound from the speaker 17 is defined as GM, and a difference in signal level at the low frequency fL between the maximum volume SPH of the speaker 17 and the minimum volume that can be set for the output sound from the speaker 17 is defined as GL. GM and GL can be calculated based on the maximum volume SPH and the volume lower limit value SPL at the reference frequency fM and the low frequency fL, respectively. When the attenuation amount of the signal level at the reference frequency fM is gM, the attenuation amount gL of the signal level at the low frequency fL is determined by using the following Equation (3).

$$gL = GL \cdot ( gM / GM ) \qquad ( 3 )$$

Here, the value of gM can be determined based on, for example, the frequency characteristic before the correction. For example, as described above, when the volume level is decreased from the maximum volume SPH, the attenuation amount from the maximum volume SPH of the frequency characteristic after the correction at the reference frequency fM can be set to be equal to the attenuation amount before the correction of the frequency characteristic. In this case, a value equal to the attenuation amount before the correction of the frequency characteristic can be used as the value of gM.

Note that in the example illustrated in FIG. 3, gM and gL are indicated based on the position of the graph line SL3 where the volume level is lowered by three levels from the maximum volume, but the volume level is not limited to the example illustrated in FIG. 3, and any decrease in volume level can be applied. This point is the same or similar in the following description.

The attenuation amount gH of the signal level at the high frequency fH can be determined in the same or a similar manner. That is, when the difference in signal level at the high frequency fH between the maximum volume SPH of the speaker 17 and the minimum volume that can be set as the output sound from the speaker 17 is GH, the attenuation amount gH of the signal level at the high frequency fH is determined by the following Equation (4).

$$gH = GH \cdot ( gM / GM ) \qquad ( 4 )$$

The rate of the attenuation amount is not necessarily limited to that illustrated in FIG. 3. For example, the attenuation rate of the attenuation amount at the predetermined frequency based on the setting of the volume level by the user may change with a set predetermined volume level as a boundary. An example of this case will be described below with reference to FIG. 4.

FIG. 4 is a diagram schematically illustrating another example of the attenuation amount of the signal level of the sound signal for each volume level. In FIG. 4, the horizontal axis represents frequency (Hz), and the vertical axis represents signal level (dB). FIG. 4 is a semi-logarithmic graph in which the horizontal axis uses a logarithmic scale. In FIG. 4, a state in which the signal level is not attenuated is defined as 0 dB, and the attenuation amount of the signal level is indicated by the magnitude of displacement in the negative direction.

The graph illustrated in FIG. 4 is different from the graph illustrated in FIG. 3 in attenuation amount of the signal level of the sound signal for each volume level. For example, in the graph illustrated in FIG. 4, at the reference frequency fM, intervals from a graph line SL0 to a graph line SL6 corresponding to the maximum volume and the six volume levels, respectively, are constant. That is, in the graph illustrated in FIG. 4, the attenuation rate of the attenuation amount at the reference frequency fM accompanying the change in volume level is constant. On the other hand, at the low frequency fL, the intervals from the graph line SL0 to the graph line SL6 corresponding to the maximum volume and the six volume levels, respectively, are not constant. For example, the intervals from the graph line SL0 to the graph line SL4 are narrower than the intervals from the graph line SL4 to the graph line SL6. This tendency is similar at the high frequency fH. In this way, in the example illustrated in FIG. 4, the attenuation rate of the attenuation amount based on the setting of the volume level changes with a predetermined volume level (the volume level corresponding to the graph line SL4 in the example of FIG. 4) as a boundary. In this example, the attenuation amount where the volume level is equal to or higher than the predetermined volume level (that is, the attenuation amount where the volume level is closer to the maximum volume than the predetermined volume level is) is smaller than that where the volume level is lower than the predetermined volume level (that is, the attenuation amount where the volume level is farther from the maximum volume than the predetermined volume level is).

Such processing by the signal processor 15 will be described in details. gM, GM, and GL are defined as those in FIG. 3. Regarding the volume level (the volume level corresponding to the graph line SL4 in the example of FIG. 4) at which the attenuation rate of the attenuation amount changes, the attenuation amount at the reference frequency fM is denoted as GMk, and the attenuation amount at the low frequency fL is denoted as GLk. GMk and GLk can be appropriately determined within the ranges of 0<GMk<GM and 0<GLk<GL, respectively. When the attenuation amount of the signal level at the reference frequency fM is gM, the attenuation amount gL of the signal level at the low frequency fL is determined by the following Equations (5).

$$\begin{matrix}gL = GLk \cdot ( gM / GMk ) & ( in a case of gM \leq GMk )\end{matrix} \qquad ( 5 )$$

$$gL = GLk + ( GL - GLk ) \cdot \{ ( gM - GMk ) / ( GM - GMk ) \} \qquad ( in a case of GMk < gM )$$

The attenuation amount gH of the signal level at the high frequency fH can be determined in the same or a similar manner. That is, GH is defined as in FIG. 3. The attenuation amount at the high frequency fH at the volume level at which the attenuation rate of the attenuation amount changes (the volume level corresponding to the graph line SL4 in the example of FIG. 4) is denoted as GHk. GHk can be appropriately determined within the range of 0<GHk<GH. When the attenuation amount of the signal level at the reference frequency fM is gM, the attenuation amount gH of the signal level at the high frequency fH is determined by the following Equations (6).

$$\begin{matrix}gH = GHk \cdot ( gM / GMk ) & ( in the case of gM \leq GMk )\end{matrix} \qquad ( 6 )$$

$$gH = GHk + ( GH - GHk ) \cdot \{ ( gM - GMk ) / ( GM - GMk ) \} \qquad ( in the case of GMk < gM )$$

In this manner, the signal processor 15 can change the attenuation rate of the attenuation amount for any k indicating the volume level serving as the boundary. Note that in the example illustrated in FIG. 4, the example in which the attenuation rate of the attenuation amount is divided into two, that is, the example in which the attenuation rate is different between the upper and lower sides of the graph SL4 in FIG. 4 has been described. However, the attenuation rate of the attenuation amount is not necessarily divided into two, and may be divided into three or more. Even when the attenuation rate is divided into three or more, the processing by the signal processor 15 can be executed by using the same or a similar idea as or to those of the above Equations (5) and (6) described with reference to FIG. 4.

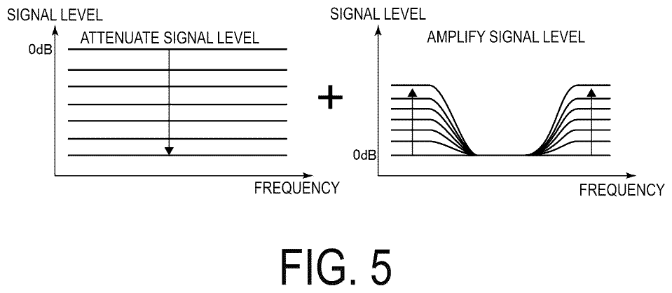

In the above embodiment, the signal processor 15 attenuates the signal level according to the volume level to perform the equalization processing. However, the signal processor 15 does not necessarily perform the equalization processing by attenuating the signal level. For example, as illustrated in FIG. 5, the signal processor 15 may perform the equalization processing by attenuating the signal level regardless of the frequency according to the volume level and amplifying the signal level of the predetermined frequency according to the volume level. The frequency at which the signal level is amplified and the amplification width thereof can be appropriately determined by using the same or a similar concept as that described in the above embodiment.

Note that, similarly to the volume lower limit value SPL described with reference to FIG. 1, the attenuation amount of the signal level may be determined for the entire predetermined frequency range by the method described with reference to FIGS. 2 and 3, or may be determined only for the reference frequency fM and the specific frequency by the method described with reference to FIGS. 2 and 3, and may be determined for the frequencies other than the reference frequency fM and the specific frequency (that is, in this example, the frequencies other than the reference frequency fM, the low frequency fL, and the high frequency fH) as values obtained by connecting the attenuation amounts determined for the reference frequency fM and the specific frequency.

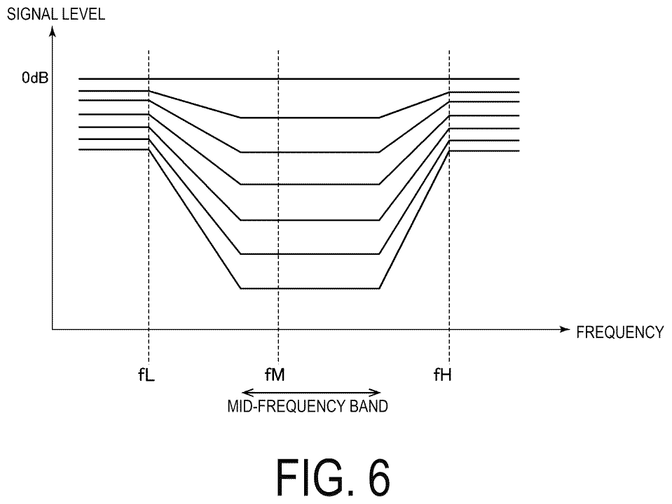

Additionally, in the above description, each of the reference frequency fM and the specific frequency is not necessarily one frequency, and may be a frequency band having a predetermined width. For example, the reference frequency fM may be a frequency band having a predetermined width including the reference frequency fM. Hereinafter, some examples related to correction of a frequency characteristic in the equalization processing will be described with reference to FIGS. 6 to 9.

FIGS. 6 to 9 are diagrams schematically illustrating an example of the attenuation amount in signal level in the equalization processing. In FIGS. 6 to 9, the horizontal axis represents frequency (Hz), and the vertical axis represents signal level (dB). FIGS. 6 to 9 are semi-logarithmic graphs in which the horizontal axis uses a logarithmic scale. In FIGS. 6 to 9, a state in which the signal level is not attenuated is defined as 0 dB, and the attenuation amount of the signal level is indicated by the magnitude of displacement in the negative direction. In the examples illustrated in FIGS. 6 to 9, a mid-frequency band including the reference frequency fM and having a predetermined width is used as the reference frequency fM.

In the examples illustrated in FIGS. 6 to 9, for the mid-frequency band, and the low frequency fL and the high frequency fH that are specific frequencies, the attenuation amount at the volume lower limit value SPL and the attenuation amount of each signal level according to the volume level are calculated and determined by the method described with reference to FIGS. 1 to 3. Frequency bands other than the mid-frequency band and the specific frequency may be determined by an appropriate method.

For example, among the other frequency bands, the attenuation amount between the low frequency fL and the mid-frequency band and the attenuation amount between the mid-frequency band and the high frequency fH can be set to have an attenuation amount characteristic with a predetermined low and continuous attenuation amount corresponding to each volume level. At this time, the attenuation amount of the signal level may be determined by connecting the low frequency fL and the mid-frequency band, and the mid-frequency band and the high frequency fH with curved lines as illustrated in FIG. 3, or may be determined by connecting the low frequency fL and the mid-frequency band, and the mid-frequency band and the high frequency fH with straight lines as illustrated in FIG. 6.

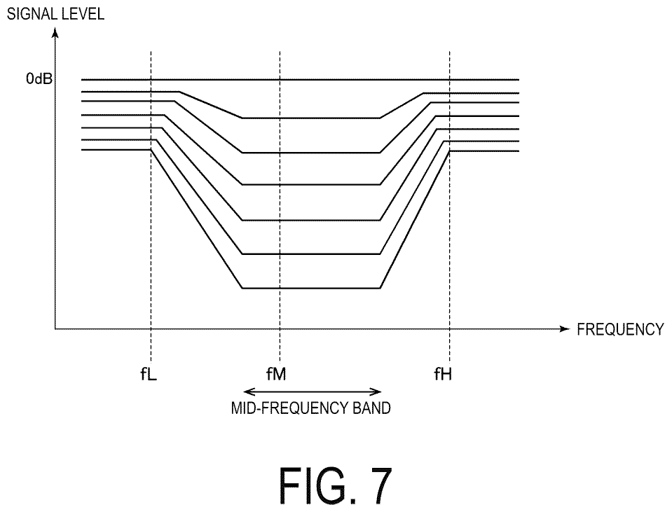

Additionally, the attenuation amount of the signal level need not necessarily change at the low frequency fL or the high frequency fH. For example, as illustrated in FIG. 7, the attenuation amount of the signal level may be determined such that the signal level does not change within a certain range on the higher frequency side than the low frequency fL and within a certain range on the lower frequency side than the high frequency fH. The certain range here may be the same range regardless of the volume levels, for example, or may be different depending on the volume levels as illustrated in FIG. 7.

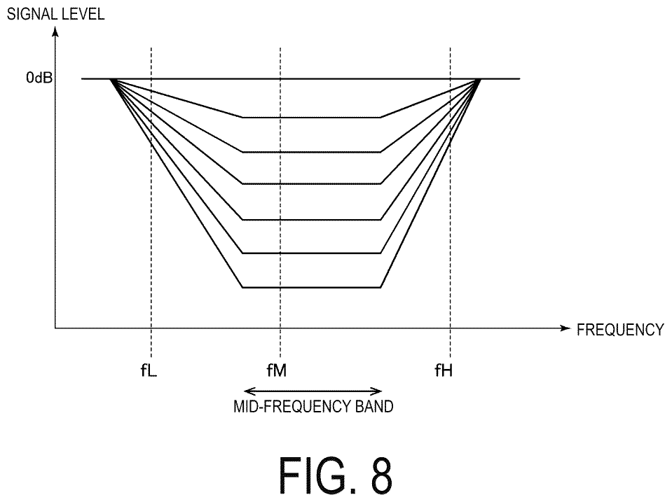

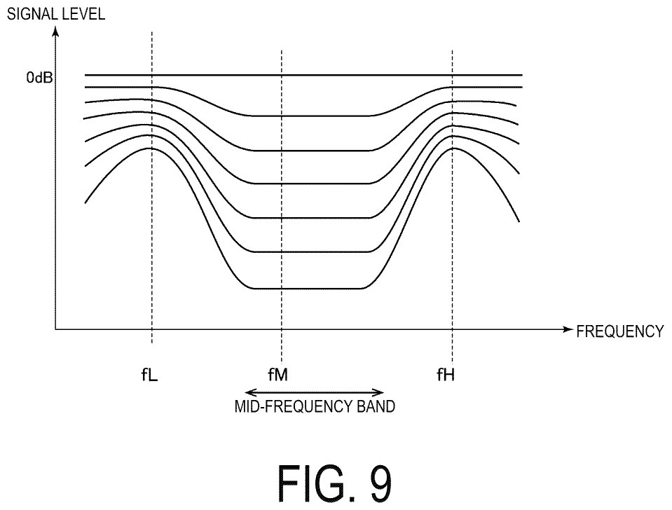

In the frequency bands on the lower frequency side than the low frequency fL and on the higher frequency side than the high frequency fH, the signal levels can be set to the same levels as those at the low frequency fL and the high frequency fH, respectively, as illustrated in FIGS. 3, 6, and 7, for example. However, the signal level need not necessarily be constant in the frequency bands on the lower frequency side than the low frequency fL and on the higher frequency side than the high frequency fH. For example, in the frequency bands on the lower frequency side than the low frequency fL and on the higher frequency side than the high frequency fH, the signal level may be determined so as to approach 0 dB as illustrated in FIG. 8, or may be determined so as to be away from 0 dB as illustrated in FIG. 9.

As described above, the signal level can be appropriately determined for frequencies other than the mid-frequency band and the specific frequencies (the low frequency fL and the high frequency fH) determined by calculation. The mid-frequency band and the specific frequencies can also be determined as appropriate.

The equalizing in the sound output apparatus 1 according to the present embodiment can be performed by determining an appropriate numerical value according to characteristics of the speaker 17 and the like. As an example, the mid-frequency band may be set to a frequency band from 1 kHz to 4 kHz, the low frequency fL may be set to 120 Hz, and the high frequency fH may be set to 12 kHz. Additionally, when the attenuation amount of the signal level in the mid-frequency band is 60 dB, the attenuation amount of the signal level at the low frequency fL can be set to 25 dB to 30 dB, and the attenuation amount of the signal level at the high frequency fH can be set to 30 dB to 35 dB. However, it is to be noted that the numerical values described here are merely examples, and the above embodiment is not used only with the numerical values described here.

As described above, in the present embodiment, the signal processor 15 corrects the frequency characteristic of the output sound from the speaker 17 such that the attenuation amount from the maximum volume of the output sound from the speaker 17 is within the range indicated by the volume lower limit value according to the volume level indicated by the volume level information. The volume lower limit value is determined according to the first sound pressure level difference and the second sound pressure level difference with reference to the difference at the reference frequency between the maximum volume of the speaker 17 and the minimum volume that can be set for the output sound from the speaker 17. In this manner, the frequency characteristic of the output sound from the speaker 17 is corrected according to the characteristic of the speaker 17. Thus, even when the volume level of the output sound is lowered, the frequency band of the sound that the user can hear is less likely to be narrowed. Thus, the sound output apparatus 1 can make the output sound from the speaker 17 easier to hear.

The equalization processing described in the above embodiment may be performed by using hardware such as a circuit, or may be performed by calculation by using software. When the calculation is performed by using software, an Infinite Impulse Response (IIR) filter and a Finite Impulse Response (FIR) filter may be used as a calculation algorithm.

Although the present disclosure has been described based on the drawings and the embodiment, it is to be noted that those skilled in the art can easily make various variations and modifications based on the present disclosure. Thus, it is to be noted that these variations and modifications are included in the scope of the present disclosure. For example, the functions included in the respective functional units can be rearranged so as not to be logically inconsistent, and a plurality of functional units and the like can be combined into one or divided.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing apparatus comprising:
a volume level information acquirer that acquires volume level information regarding a setting of a volume level by a user; and
a signal processor that corrects a frequency characteristic of an output sound from a speaker and thus causes an attenuation amount from a maximum volume of the output sound from the speaker at a predetermined frequency to be within a range indicated by a volume lower limit value relative to the maximum volume at the predetermined frequency, according to the volume level indicated by the volume level information, wherein
the volume lower limit value is determined according to a first sound pressure level difference at a reference frequency between the maximum volume of the speaker and a minimum audible volume that a human is capable of hearing and a second sound pressure level difference at different frequency different from the reference frequency between the maximum volume and the minimum audible volume, with a difference at the reference frequency between the maximum volume and a minimum volume that is settable for the output sound from the speaker as a reference.

2. The information processing apparatus according to claim 1, wherein
the volume lower limit value is determined according to the first sound pressure level difference and the second sound pressure level difference for each of the reference frequency and the different frequency, and is determined, for a frequency other than the reference frequency and the different frequency, as a value obtained by connecting the volume lower limit value determined for the reference frequency and the volume lower limit value determined for the different frequency.

3. The information processing apparatus according to claim 1, wherein
the different frequency includes a low frequency lower than the reference frequency and a high frequency higher than the reference frequency.

4. The information processing apparatus according to claim 1, wherein
the attenuation amount is determined based on a ratio between the first sound pressure level difference and the second sound pressure level difference.

5. The information processing apparatus according to claim 4, wherein
an attenuation rate of the attenuation amount at the predetermined frequency based on the setting of the volume level by the user is identical to an attenuation rate of an attenuation amount at the reference frequency.

6. The information processing apparatus according to claim 4, wherein
an attenuation rate of the attenuation amount at the predetermined frequency based on the setting of the volume level by the user changes with a set predetermined volume level as a boundary.

7. An information processing method that is executed by an information processing apparatus, the information processing method comprising:
acquiring volume level information regarding a setting of a volume level by a user; and
correcting a frequency characteristic of an output sound from a speaker and thus causing an attenuation amount from a maximum volume of the output sound from the speaker at a predetermined frequency to be within a range indicated by a volume lower limit value relative to the maximum volume at the predetermined frequency, according to the volume level indicated by the volume level information, wherein
the volume lower limit value is determined according to a first sound pressure level difference at a reference frequency between the maximum volume of the speaker and a minimum audible volume that a human is capable of hearing and a second sound pressure level difference at a different frequency different from the reference frequency between the maximum volume and the minimum audible volume, with a difference at the reference frequency between the maximum volume and a minimum volume that is settable for the output sound from the speaker as a reference.
